(19) United States
(12) Patent Application Publication
(10) Pub. No.: US 2026/0203878 A1
(43) Pub. Date: Jul. 16, 2026

(54) UNSUPERVISED BOREHOLE IMAGE CLUSTERING

(71) Applicant: Schlumberger Technology Corporation, Sugar Land, TX (US)

(72) Inventors: Gurami Keretchashvili, Clamart (FR); Ting Lei, Arlington, MA (US); Lin Liang, Belmont, MA (US)

(21) Appl. No.: 19/446,983

(22) Filed: Jan. 13, 2026

Related U.S. Application Data
(60) Provisional application No. 63/744,427, filed on Jan. 13, 2025.

(51) Int. Cl. G06T 5/77; G06T 5/60

(52) U.S. Cl. CPC G06T 5/77; G06T 5/60

(57) ABSTRACT

An embodiment of a method for unsupervised analysis of borehole image data is provided in which a borehole image is divided into a plurality of image patches, and missing or degraded measurements within at least a portion of the image patches are reconstructed. The method further provides for generating feature embeddings for the reconstructed image patches and processing to enable grouping of image patches that exhibit similar geological texture characteristics. The resulting group assignments are then mapped back to depth-indexed intervals of the borehole image, thereby producing an automated representation of recurring geological textures without requiring labeled training data.

### RELATED APPLICATION

This application claims priority to and the benefit of a US Provisional Application having Serial No. 63/744,427, filed January 13, 2025, which is incorporated by reference herein in its entirety.

### BACKGROUND

### Field of the Disclosure

The present disclosure relates generally to processing and interpretation of borehole image logs obtained from subsurface wellbores. More particularly, the disclosure relates to systems and methods for unsupervised clustering of micro-resistivity borehole images, including preprocessing, cylindrical padding, gap inpainting, self-supervised feature embedding, dimensionality reduction, and cluster assignment for automated geological interpretation.

### Description of Related Art

Borehole image logs, including micro-resistivity and ultrasonic images, are widely used for geological interpretation and reservoir characterization. These images may capture bedding, fractures, faults, drilling-induced features, breakouts, voids, and a variety of sedimentary textures. Acquisition tools, however, frequently produce incomplete images due to pad gaps, missing button measurements, standoff, rotational motion, or electrical noise. As a result, borehole images often contain vertically elongated gaps and irregular missing regions that complicate both manual and automated interpretation.

Conventional interpretation workflows require skilled geologists to manually identify and annotate geological textures, a process that is labor-intensive, subjective, and inconsistent across practitioners. Automated approaches typically rely on supervised machine learning, but such methods require large, labeled datasets that are seldom available for borehole images. Labels are expensive, difficult to standardize, and highly formation-dependent, resulting in models that do not generalize well to new basins, lithologies, or tool types.

Furthermore, borehole images exhibit a cylindrical geometry, where the left and right image edges correspond to adjacent circumferential positions around the borehole wall. Standard image-processing models assume planar topology, leading to discontinuities at the circumferential boundary and unreliable predictions near image edges.

Existing interpolation or inpainting approaches struggle with large missing regions, particularly when gaps span multiple pad widths. Even modern deep-learning inpainting models are prone to producing discontinuities or unrealistic geological textures if the cylindrical adjacency is not preserved.

Accordingly, there is a need for an unsupervised image-clustering framework capable of: (1) preserving cylindrical continuity; (2) reconstructing missing data using deep-learning inpainting; (3) generating self-supervised texture embeddings; (4) reducing embedding dimensionality while preserving geological structure; and (5) performing unsupervised clustering to produce interpretable depth-wise logs.

The present disclosure addresses these needs.

### SUMMARY

In one aspect, the present disclosure provides a method for unsupervised analysis of borehole image data in which a borehole image is divided into a plurality of image patches, and missing or degraded measurements within at least a portion of the image patches are reconstructed. Feature embeddings are generated for the reconstructed image patches and processed to enable grouping of image patches that exhibit similar geological texture characteristics. The resulting group assignments are then mapped back to depth-indexed intervals of the borehole image, thereby producing an automated representation of recurring geological textures without requiring labeled training data.

In another aspect, the present disclosure provides a method in which overlapping image patches are extracted from a borehole image at successive depth positions and circumferential positions. Missing or degraded measurements within the image patches are reconstructed using an inpainting operation, and feature embeddings are generated for the reconstructed patches using a machine-learning model. The feature embeddings are processed using a nonlinear dimensionality-reduction technique and clustered using a density-based clustering algorithm to identify groups of image patches having similar geological texture characteristics.

In a further aspect, the present disclosure provides a method in which overlapping image patches are generated from a borehole image along depth and circumferential positions and are cylindrically padded to preserve circumferential continuity. Missing or degraded measurements within the padded image patches are reconstructed using a deep-learning-based inpainting model, and feature embeddings are generated using a self-supervised vision transformer. The feature embeddings are normalized, reduced in dimensionality using a nonlinear manifold-learning technique, and clustered using a density-based clustering algorithm to generate cluster assignments that are aggregated into a depth-wise cluster log representing recurring geological textures along the borehole.

### BRIEF DESCRIPTION OF DRAWINGS

The appended figures illustrate only exemplary embodiments and are therefore not to be considered limiting of the scope of the disclosure, as the disclosure may admit to other equally effective embodiments.

FIG. 1 illustrates an example borehole imaging system deployed in a borehole, including a downhole tool having imaging pads configured to acquire micro-resistivity measurements of the borehole wall.

FIG. 2 illustrates an example unwrapped micro-resistivity borehole image generated from measurements acquired by the borehole imaging system of FIG. 1, showing vertically elongated regions of missing or degraded measurements arising from pad spacing and standoff.

FIG. 3 illustrates an example end-to-end modular workflow for unsupervised analysis and clustering of borehole image data, including patch generation, inpainting, representation computation, optional normalization, optional dimensionality reduction, and clustering.

FIG. 4 illustrates an example implementation of cylindrical padding applied to an image patch, showing how padding regions are added to opposing lateral edges of the patch to preserve circumferential continuity prior to inpainting

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The following detailed description is provided to enable a person skilled in the art to practice the present disclosure. Various modifications will be apparent to skilled practitioners, and the general principles described herein may be applied to other embodiments and applications without departing from the scope of the present disclosure. The detailed description is therefore not intended to be limiting.

Modern micro-resistivity borehole imaging tools acquire high-resolution measurements of the borehole wall using multiple pads distributed circumferentially around a downhole tool body. Each pad includes a set of button electrodes that inject electrical current into the formation and measure the resulting voltage response. As the tool traverses the borehole, these measurements are assembled into a circumferential image representing geological textures, bedding, fractures, breakouts, and other structures of interest.

Due to inherent limitations in pad-based imaging tools, raw images often contain substantial gaps or degraded regions. Circumferential coverage is incomplete because pads occupy only a subset of the borehole circumference. Standoff effects, caused by tool decentralization, borehole washouts, or irregularities along the wall, may prevent buttons from contacting the formation, resulting in vertically elongated columns of missing measurements. These issues produce discontinuities in the acquired image that obscure geological textures and hinder downstream interpretation.

Traditional workflows rely heavily on manual interpretation or supervised learning approaches that require large labeled datasets. Such datasets are rarely available, costly to annotate, and often tool and/or formation-specific. As a result, supervised models frequently generalize poorly across basins or tool designs. In contrast, the present disclosure provides a workflow that operates without labeled geological data, using a combination of cylindrical padding, neural inpainting, self-supervised embedding generation, nonlinear dimensionality reduction, and density-based clustering to generate automated cluster logs representing geological textures in a depth-wise format.

The workflow disclosed herein addresses these challenges by reconstructing missing regions in a manner consistent with the cylindrical geometry of the borehole, generating feature embeddings, robust to tool-related measurement variability, and performing unsupervised clustering to produce interpretable geological intervals.

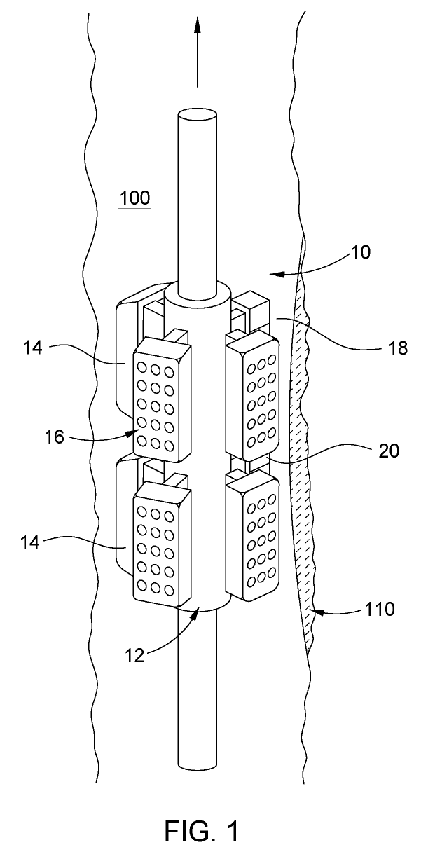

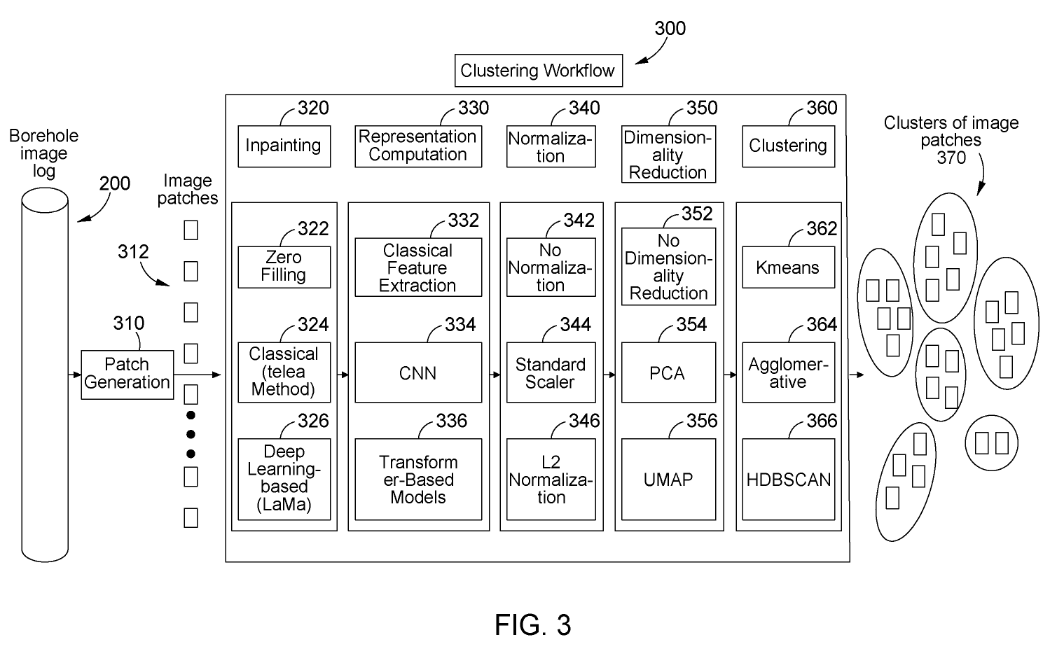

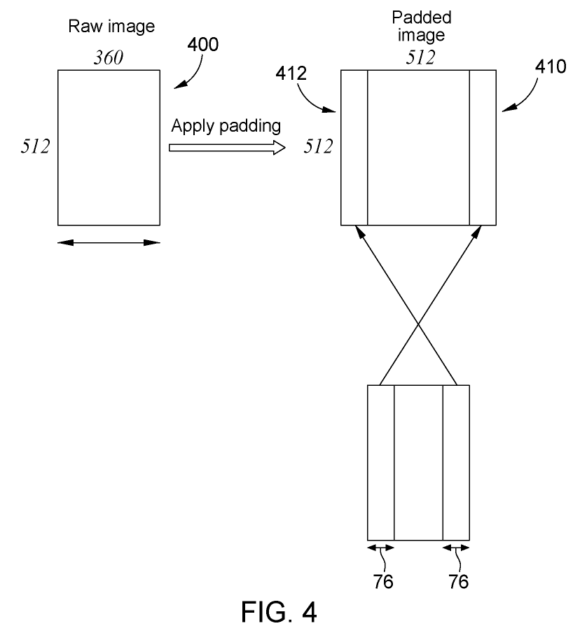

As will be described in subsequent figures, the standoff regions and pad-coverage gaps illustrated in FIG. 1 directly lead to the vertically elongated voids and circumferential discontinuities observed in FIGS. 3 and 4. These acquisition-related measurement effects motivate the cylindrical-padding and neural-inpainting stages of the disclosed workflow, which restore geological continuity before feature extraction and clustering.

FIG. 1 illustrates an example borehole imaging system suitable for use with embodiments of the present disclosure. The system includes a logging tool 10 deployed within a borehole 100 and configured to acquire high-resolution micro-resistivity images of the wall 110 of the borehole 100. The logging tool 10 comprises a tool body 12 and a plurality of imaging pads 14 distributed circumferentially around the logging tool 10. Each imaging pad 14 includes a number of button electrodes 16 arranged in multiple vertical rows. The imaging pads 14 are configured to contact or approach the wall 110 of the borehole 110110 during logging.

As the logging tool 10 traverses the borehole 100, each button electrode 16 measures electrical properties of the surrounding formation at its point of contact or proximity. This produces a vertically continuous stream of resistivity measurements for each button electrode 16. However, because the imaging pads 14 cover only a portion of the 360-degree circumference, gaps 18 exist between adjacent imaging pads 14, resulting in circumferential sectors without measurements. Additionally, regions of standoff 20 (i.e. regions where the imaging pads 14 do not fully contact the wall 110 of the borehole 100), create vertically elongated columns of missing data or degraded measurements.

Other example borehole imaging systems suitable for use with embodiments of the present disclosure may include centralizers, arms, springs, or other mechanisms for maintaining contact between the imaging pad 14 and the wall 110 of the borehole 100; however, irregular conditions of the borehole 100 may still cause complete or partial contact loss, resulting in missing data patters as described above.

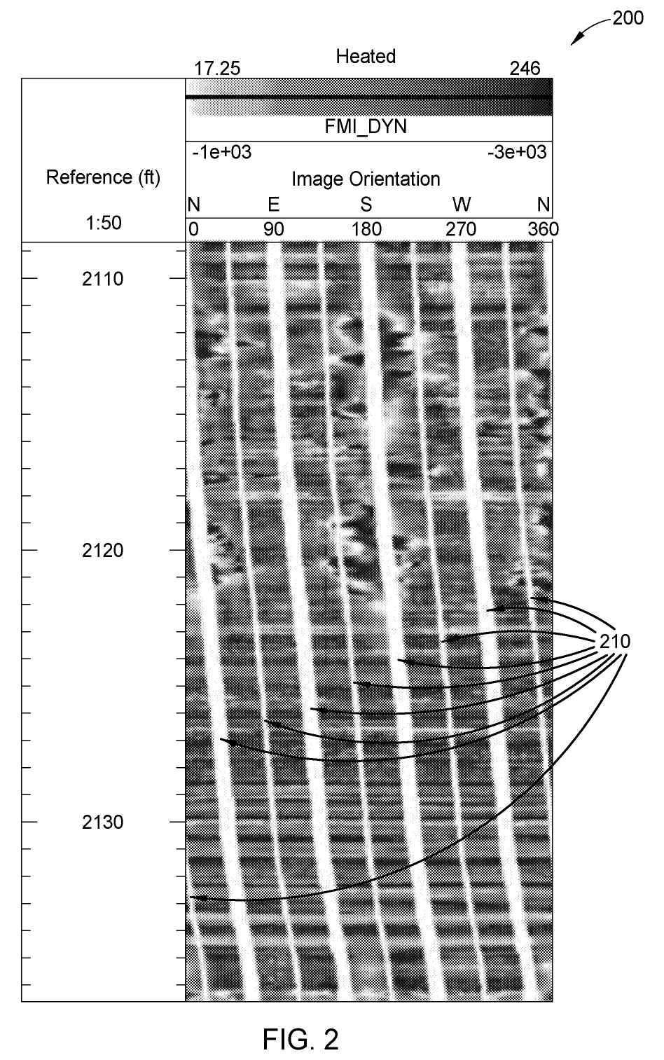

FIG. 2 illustrates an example unwrapped micro-resistivity borehole image 200 generated from measurements acquired by a borehole imaging tool 10 such as that illustrated in FIG. 1. The image 200 is represented in a two-dimensional format in which a vertical axis corresponds to depth along the borehole 100 and a horizontal axis corresponds to circumferential position around the borehole wall 110. Each pixel or small group of pixels represents a resistivity measurement acquired by a corresponding button electrode as the tool 10 traverses the borehole 100.

As shown in FIG. 2, the borehole image 200 includes a plurality of vertically elongated regions 210 of missing or degraded data that appear as stripes or bands extending along the depth direction. These elongated regions 210 correspond directly to the physical acquisition limitations illustrated in FIG. 1. In particular, circumferential gaps 18 between adjacent imaging pads 14 produce sectors of the borehole wall 110 that are not sampled by any button electrode 16, while standoff 20 between one or more pads 14 and the borehole wall 110 results in intervals where electrodes fail to obtain reliable electrical contact with the formation. Because these effects persist over depth as the tool 10 moves through the borehole 100, they manifest in the image 200 as vertically, continuous or semi-continuous, regions 210 of missing or degraded data.

The missing-data patterns illustrated in FIG. 2 are therefore not random noise, but are structured, vertically elongated regions of missing or degraded measurements that are highly correlated with the geometry and dynamics of the borehole imaging tool 10 shown in FIG. 1. These elongated regions 210 frequently intersect geological features of interest, such as bedding planes, fractures, or resistivity contrasts, thereby fragmenting otherwise continuous textures and complicating both visual interpretation and automated analysis. For example, a single dipping bed or fracture trace may be split into multiple disconnected segments by the locations of pad gaps 18 or regions where standoff 20 exists.

The borehole image 200 of FIG. 2 is cylindrical, with the left and right edges of the image corresponding to adjacent circumferential positions on the borehole wall 110. However, when represented in a planar, unwrapped format, this cylindrical continuity is not explicitly preserved, and the circumferential seam between the edges of the image 200 may introduce artificial discontinuities. These discontinuities can further degrade the performance of downstream image-processing or machine-learning algorithms if not properly accounted for.

In certain embodiments, FIG. 2 may represent a raw borehole image 200 prior to any reconstruction or preprocessing. In other embodiments, FIG. 2 may represent a partially processed image 200, such as an image that has undergone basic preprocessing or normalization but has not yet been subjected to the workflow of the present disclosure, such as cylindrical padding, inpainting, or clustering, as described herein. Regardless of the specific preprocessing state, FIG. 2 illustrates the fundamental relationship between the physical acquisition tool geometry of FIG. 1 and the resulting patterns of missing or degraded measurements that the disclosed workflow of the present disclosure addresses.

FIG. 3 illustrates an example end-to-end modular workflow 300 for unsupervised analysis and clustering of borehole image data, according to certain embodiments of the present disclosure. The workflow 300 operates on a borehole image such as the unwrapped micro-resistivity borehole image 200 shown in FIG. 2, which contains vertically elongated regions of missing or degraded measurements arising from the physical acquisition geometry of the borehole imaging system illustrated in FIG. 1. FIG. 3 depicts how the borehole image is progressively transformed into clusters of image patches representing recurring geological textures.

As shown in FIG. 3, the workflow 300 comprises a sequence of ordered processing steps, including patch generation 310, inpainting 320, representation computation 330, optional normalization 340, optional dimensionality reduction 350, and clustering 360. Each processing step is shown as a functional block, and FIG. 3 further indicates that multiple techniques or methods may be employed within each step. The workflow 300 ultimately produces image patch clusters 370, which may be mapped back to depth-indexed intervals of the borehole image.

In an embodiment of the patch generation step 310 of the workflow 300, a plurality of image patches 312 are generated from the borehole image 200 using a sliding-window operation. The sliding window is a computational construct that extracts localized, rectangular subsets of the unwrapped borehole image at successive depth positions and circumferential positions. Each image patch 312 represents a localized portion of the borehole wall and typically includes both geological texture information and portions of the vertically elongated regions of missing or degraded measurements illustrated in FIG. 2.

Patch size, overlap, and spacing between successive patches may be selected based on image resolution, anticipated geological feature scale, or the spatial extent of missing or degraded measurements. In certain embodiments, overlapping image patches 312 are generated so that a given depth interval is represented by multiple patches. Such overlap helps preserve continuity of bedding planes, laminations, or fracture traces across patch boundaries and supports later aggregation of patch-level results to improve robustness.

In some embodiments, the dimensions of the image patches 312 may be adaptively selected based on local image characteristics. For example, intervals exhibiting strong circumferential variation, pronounced bedding fabric, or cyclic textures may be represented using patches having a larger circumferential extent, whereas intervals containing localized fractures or rapidly varying textures may be represented using patches having a shorter vertical extent. More generally, patch dimensions may be selected to balance geological texture capture, computational efficiency, and sensitivity to elongated regions of missing or degraded measurements. Example patch geometry and associated cylindrical padding effects are illustrated and discussed in further detail with reference to FIG. 4.

In a subsequent inpainting step 320 of the workflow 300, missing or degraded regions within each image patch 312 are reconstructed using an inpainting operation. FIG. 3 illustrates that the inpainting step 320 may be implemented using different techniques, including zero filling 322, classical image reconstruction techniques 324, and deep-learning-based inpainting techniques 326. The selection of an inpainting technique may depend on the size, geometry, and persistence of missing regions within the image patches 312.

In some embodiments, zero filling 322 or interpolation-based reconstruction techniques 324 are used to estimate missing pixel values from neighboring measurements. Such approaches may be sufficient for small, isolated missing regions, but generally perform less effectively when missing regions are vertically elongated or persist across multiple depth intervals, as commonly occurs due to pad spacing or sustained standoff illustrated in FIGS. 1 and 2.

In embodiments of the present disclosure, the inpainting step 320 is implemented using a deep-learning-based inpainting technique 326, such as a Large Mask Inpainting (LaMa) model. LaMa-based models are designed to reconstruct large, irregular missing regions by leveraging long-range spatial context. This capability is particularly suited to borehole images, in which missing regions frequently extend continuously over substantial depth intervals.

When applied to borehole image patches 312, LaMa-based inpainting techniques infer plausible geological textures within elongated missing regions by extrapolating bedding continuity, fracture geometry, and resistivity contrast from surrounding intact measurements. In intervals affected by sustained standoff, where multiple pads lose contact with the borehole wall over extended depths, the inpainting operation leverages contextual information on both sides of the missing region to reconstruct textures that would otherwise remain fragmented using classical reconstruction methods.

In certain embodiments, cylindrical padding is applied prior to or as part of the inpainting step 320 to enforce circumferential continuity. Because the left and right edges of the unwrapped borehole image correspond to adjacent circumferential positions on the borehole wall, cylindrical padding ensures that the inpainting model receives a consistent boundary context. This enables reconstruction of geological features that cross the circumferential seam, such as dipping beds or fracture traces, and improves reconstruction quality in intervals containing large missing regions. Example implementations of cylindrical padding are illustrated and discussed in further detail with reference to FIG. 4 discussed below.

Following inpainting, each reconstructed image patch 312 is processed by a representation computation step 330 to generate a numerical feature representation that characterizes the geological texture of the patch. As illustrated in FIG. 3, representation computation 330 may be implemented using classical feature extraction techniques 332, convolutional neural networks 334, or transformer-based models 336.

In embodiments of the present disclosure, representation computation 330 is performed using pretrained self-supervised vision transformer models such as DINO, DINOv2 and Dinov2 with registers. These models generate feature embeddings that encode geological texture attributes including bedding style, lamination patterns, fracture geometry, resistivity contrast, and heterogeneity, while remaining robust to variability introduced by acquisition conditions.

In certain embodiments, DINOv2 model incorporating register tokens are employed. The use of register tokens enables improved aggregation of global contextual information across the image patch and may enhance separation of geological textures that exhibit subtle but consistent patterns across depth.

Feature embeddings generated in the representation computation step 330 may be derived from class tokens, pooled patch tokens, or combinations thereof. Embedding dimensionality may vary depending on model size and extraction strategy and may range, for example, from approximately 384 to approximately 1536 dimensions. In embodiments of the present disclosure, embedding dimensionalities on the order of several hundred dimensions provide a balance between representational expressiveness and computational efficiency.

In some embodiments, the feature embeddings generated in step 330 are optionally processed using a normalization step 340. In some embodiments, no normalization 342 takes place, while in other embodiments, standard scaling 344 is used, while in other embodiments the normalization may include operations such as L1 normalization, L2 normalization 346, or other scaling techniques applied in embedding space.

In embodiments of the present disclosure, L2 normalization 346 is applied such that each feature embedding has unit length. This reduces sensitivity to variations in embedding magnitude while preserving relative geometric relationships among embeddings, which can improve stability and consistency in subsequent dimensionality reduction or clustering operations.

A dimensionality reduction step 350 is an optional module within embodiments of the workflow. In certain embodiments, feature embeddings are clustered directly in their original high-dimensional representation space and so no dimensional reduction takes place 352. In other embodiments, dimensionality reduction is applied in step 350 to compress the feature embeddings into a lower-dimensional representation prior to clustering.

Dimensionality reduction may be performed using linear techniques such as principal component analysis (PCA) 354, which project the embeddings onto a reduced set of orthogonal components capturing dominant variance. PCA may be useful for emphasizing broad textural trends while reducing noise and computational cost.

In embodiments of the present disclosure, dimensionality reduction is performed using nonlinear manifold-learning techniques such as Uniform Manifold Approximation and Projection (UMAP) 356. UMAP preserves local neighborhood relationships while maintaining global structure, enabling effective separation of geological textures that differ subtly in bedding style, fracture density, or resistivity contrast.

UMAP parameters, including the number of neighbors and minimum distance, may be tuned to emphasize broader geological coherence or finer-scale textural differentiation, depending on interpretive objectives and data characteristics.

In a clustering step 360 of the workflow 300, the feature representations are grouped into image patch clusters 370 representing distinct geological textures. Each cluster 370 corresponds to a set of image patches 312 exhibiting similar texture characteristics in the feature representation space.

Clustering may be performed using centroid-based methods, such as K-means clustering 362, agglomerative hierarchical clustering techniques 364, or density-based clustering algorithms. In embodiments of the present disclosure, clustering is performed using Hierarchical Density-Based Spatial Clustering of Applications with Noise (HDBSCAN) 366, which identifies clusters of varying shape and density without requiring prior specification of the number of clusters.

Image patches 312 identified as not belonging to any stable cluster 370 frequently correspond to transitional geological intervals or regions affected by sustained standoff or degraded measurements. Isolating such patches prevents these effects from distorting the resulting geological segmentation and improves interpretive clarity.

Cluster 370 assignments for individual image patches 312 are mapped back to depth-indexed intervals of the borehole image. In embodiments employing overlapping patches 312, cluster 370 labels may be aggregated using majority voting, probability-weighted combination, or smoothing operations to generate a continuous, depth-wise cluster log.

The resulting cluster 370 logs provide practical interpretive value by identifying recurring geological textures, stratigraphic boundaries, fracture-dominated intervals, or anomalous texture zones. Because the workflow operates without labeled training data, it may reveal texture classes or transitions that are not pre-defined.

In some embodiments, components of the workflow may be evaluated using quantitative measures during development or validation. For example, inpainting quality may be assessed using image similarity metrics such as peak signal-to-noise ratio (PSNR), structural similarity index (SSIM), or a Variance Similarity Analysis (VSA) metric, by comparing reconstructed patches against reference images or synthetically masked inputs. Such evaluations are not required for deployment of the workflow.

FIG. 4 illustrates an example implementation of cylindrical padding referenced in the workflow of FIG. 3. The figure provides additional detail regarding how circumferential continuity of image patches is preserved prior to the inpainting step 320.

FIG. 4 illustrates a conceptual representation of cylindrical padding applied to an image patch 400 generated from the unwrapped borehole image. As shown, the borehole image spans a full circumferential range when unwrapped, but includes incomplete circumferential coverage due to the arrangement of imaging pads around the tool, as described with reference to FIG. 1.

To preserve circumferential continuity, padding regions 410 and 412 are added to opposing lateral edges of the image patch 400. Image content from one circumferential edge of the patch 400 is replicated or wrapped to the opposite edge, reflecting the physical adjacency of these positions on the borehole wall. This ensures that circumferentially continuous geological features are treated as continuous during subsequent processing.

FIG. 4 further illustrates the effect of cylindrical padding on patch geometry, in which the circumferential extent of an image patch 400 is expanded by adding padding regions (410, 412) to opposing sides. In a non-limiting example, an image patch 400 having an initial circumferential width on the order of a few hundred pixels may be expanded by padding (410, 412) to a larger circumferential width to provide additional contextual information across the circumferential seam. For example, as illustrated in FIG. 4, a patch having an initial circumferential width of approximately 360 pixels may be expanded by adding padding regions (410, 412) of approximately 76 pixels to each opposing side. The padded patch preserves the original spatial relationships of the image content while enabling subsequent processing steps to treat circumferentially adjacent features as continuous.

By preserving circumferential continuity prior to inpainting, cylindrical padding improves reconstruction of elongated regions of missing or degraded measurements that extend across the circumferential seam. Geological features such as bedding planes or fracture traces that cross the seam are more faithfully reconstructed when padding is applied.

The cylindrical padding illustrated in FIG. 4 thus supports the inpainting step 320 of the workflow by providing consistent circumferential context to the reconstruction operation, particularly in intervals affected by pad gaps or sustained standoff.

### Example Clauses

Implementation examples are described in the following numbered clauses:

Aspect 1: A method for unsupervised analysis of borehole image data, comprising:(a) generating a plurality of image patches from a borehole image; (b) reconstructing missing data within at least a portion of the image patches; (c) generating feature embeddings for the reconstructed image patches; (d) reducing dimensionality of the feature embeddings; (e) clustering the reduced-dimension feature embeddings to identify groups of image patches exhibiting similar geological texture characteristics; and (f) mapping cluster assignments to depth-indexed intervals of the borehole image.

Aspect 2: The method of Aspect 1, wherein generating the plurality of image patches comprises extracting overlapping image patches at successive depth positions.

Aspect 3: The method of Aspect 1, wherein reconstructing missing data comprises filling missing pixels with a constant value.

Aspect 4: The method of Aspect 1, wherein reconstructing missing data comprises reconstructing missing pixels using an interpolation-based technique.

Aspect 5: The method of Aspect 1, wherein reconstructing missing data comprises applying a deep-learning-based inpainting model.

Aspect 6: The method of Aspect 1, wherein generating feature embeddings comprises extracting texture features from the reconstructed image patches.

Aspect 7: The method of Aspect 1, wherein generating feature embeddings comprises applying a transformer-based neural network to the reconstructed image patches.

Aspect 8: The method of Aspect 1, wherein reducing dimensionality comprises applying a linear dimensionality-reduction technique.

Aspect 9: The method of Aspect 1, wherein clustering comprises grouping the feature embeddings using a centroid-based clustering algorithm.

Aspect 10: The method of Aspect 1, wherein mapping cluster assignments comprises aggregating cluster labels from overlapping image patches.

Aspect 11: A method for unsupervised analysis of borehole image data, comprising: (a) extracting overlapping image patches from a borehole image at successive depth positions and circumferential positions; (b) reconstructing missing data within the image patches using an inpainting operation; (c) generating feature embeddings for the reconstructed image patches using a machine-learning model; (d) reducing dimensionality of the feature embeddings using a nonlinear dimensionality-reduction technique; and (e) clustering the reduced-dimension feature embeddings using a density-based clustering algorithm.

Aspect 12: The method of Aspect 11, wherein the inpainting operation comprises reconstructing missing data using a deep-learning-based inpainting model.

Aspect 13: The method of Aspect 11, wherein generating feature embeddings comprises applying a self-supervised learning model trained without labeled geological data.

Aspect 14: The method of Aspect 11, further comprising normalizing the feature embeddings prior to reducing dimensionality.

Aspect 15: The method of Aspect 14, wherein normalizing the feature embeddings comprises L2 normalization.

Aspect 16: The method of Aspect 11, wherein clustering further comprises identifying noise points that do not belong to any stable cluster.

Aspect 17: A method for unsupervised analysis of borehole image data, comprising: (a) generating overlapping image patches from a borehole image along depth and circumferential position; (b) cylindrically padding the image patches to enforce circumferential continuity; (c) reconstructing missing data within the padded image patches using a deep-learning-based inpainting model; (d) generating feature embeddings for the reconstructed image patches using a pretrained self-supervised vision transformer models; (e) L2-normalizing the feature embeddings; (f) reducing dimensionality of the normalized feature embeddings using Uniform Manifold Approximation and Projection (UMAP); (g) clustering the reduced-dimension feature embeddings using Hierarchical Density-Based Spatial Clustering of Applications with Noise (HDBSCAN); and (h) aggregating cluster assignments to generate a depth-wise cluster log.

Aspect 18: The method of Aspect 17, wherein the self-supervised vision transformer comprises a DINO-based or DINOv2-based architecture.

Aspect 19: The method of Aspect 17, wherein clustering using HDBSCAN identifies image patches that do not belong to a stable cluster.

Aspect 20: The method of Aspect 17, wherein aggregating cluster assignments comprises aggregating cluster labels from overlapping images using probability-weighted combinations.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. §112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for unsupervised analysis of borehole image data, comprising:
generating a plurality of image patches from a borehole image;
reconstructing missing data within at least a portion of the image patches to create reconstructed image patches;
generating feature embeddings for the reconstructed image patches;
reducing dimensionality of the feature embeddings to create reduced-dimensionality feature embeddings;
clustering the reduced-dimensionality feature embeddings to identify groups of image patches exhibiting similar geological texture characteristics; and
mapping cluster assignments to depth-indexed intervals of the borehole image.

2. The method of claim 1, wherein generating the plurality of image patches comprises extracting overlapping image patches at successive depth positions.

3. The method of claim 1, wherein reconstructing missing data comprises filling missing pixels with a constant value.

4. The method of claim 1, wherein reconstructing missing data comprises reconstructing missing pixels using an interpolation-based technique.

5. The method of claim 1, wherein reconstructing missing data comprises applying a deep-learning-based inpainting model.

6. The method of claim 1, wherein generating feature embeddings comprises extracting feature representations characterizing texture from the reconstructed image patches.

7. The method of claim 1, wherein generating feature embeddings comprises applying a transformer-based neural network to the reconstructed image patches.

8. The method of claim 1, wherein reducing dimensionality comprises applying a linear dimensionality-reduction technique.

9. The method of claim 1, wherein clustering comprises grouping the feature embeddings using a centroid-based clustering algorithm.

10. The method of claim 1, wherein mapping cluster assignments comprises aggregating cluster labels from overlapping image patches.

11. A method for unsupervised analysis of borehole image data, comprising:
extracting overlapping image patches from a borehole image at successive depth positions and circumferential positions;
reconstructing missing data within the image patches using an inpainting operation to create reconstructed image patches;
generating feature embeddings for the reconstructed image patches using a machine-learning model;
reducing dimensionality of the feature embeddings using a nonlinear dimensionality-reduction technique to create reduced-dimension feature embeddings; and
clustering the reduced-dimension feature embeddings using a density-based clustering algorithm.

12. The method of claim 11, wherein the inpainting operation comprises reconstructing missing data using a deep-learning-based inpainting model.

13. The method of claim 11, wherein generating feature embeddings comprises applying a self-supervised learning model trained without labeled geological data.

14. The method of claim 11, further comprising normalizing the feature embeddings prior to reducing dimensionality.

15. The method of claim 14, wherein normalizing the feature embeddings comprises L2 normalization.

16. The method of claim 11, wherein clustering further comprises identifying noise points that do not belong to any stable cluster.

17. A method for unsupervised analysis of borehole image data, comprising:
generating overlapping image patches from a borehole image along depth and circumferential position;
cylindrically padding the image patches to enforce circumferential continuity;
reconstructing missing data within the cylindrically padded image patches using a deep-learning-based inpainting model;
generating feature embeddings for the cylindrically padded image patches using a pretrained self-supervised vision transformer model;
L2-normalizing the feature embeddings;
reducing dimensionality of the normalized feature embeddings to create reduced-dimensionality feature embeddings using Uniform Manifold Approximation and Projection (UMAP);
clustering the reduced-dimensionality feature embeddings to create cluster assignments using Hierarchical Density-Based Spatial Clustering of Applications with Noise (HDBSCAN); and
aggregating the cluster assignments to generate a depth-wise cluster log.

18. The method of claim 17, wherein the self-supervised vision transformer comprises a DINO-based or DINOv2-based architecture.

19. The method of claim 17, wherein clustering using HDBSCAN identifies image patches that do not belong to a stable cluster.

20. The method of claim 17, wherein aggregating the cluster assignments comprises aggregating cluster labels from overlapping image patches using probability-weighted combinations.
